(19) United States
(12) Patent Application Publication
(10) Pub. No.: US 2023/0173314 A1
(43) Pub. Date: Jun. 8, 2023

(54) Intumescent Cover or Joiner

(71) Applicant: Ashmere Holdings Pty Ltd, Bayswater (AU)

(72) Inventor: Colin James Ayres, Bayswater (AU)

(21) Appl. No.: 17/554,523

(22) Filed: Dec. 17, 2021

(30) Foreign Application Priority Data
Dec. 6, 2021 (AU) 2021282399

(51) Int. Cl. A62C 2/06; A62C 3/10

(52) U.S. Cl. CPC A62C 2/065; A62C 3/10; B63B 3/48

(57) ABSTRACT

A cover or joiner is configured to cover the respective channels and/or joins between adjacent thermal insulation panels of a structural fire protection system, such as for marine vessel deckheads and bulkheads. The cover or joiner can include an elongate member, such as a strip, that includes intumescent insulation, and optionally can include one or more fastener arrangements, such as use of holes for attaching the cover or joiner to the underlying thermal insulation panels and support framework. The cover or joiner can be insulated with 6 mm thick intumescent insulation material and attached (e.g., screwed) to the framework. A front face of the cover or joiner (front facing away from the panels) can be of metal, such as stainless steel or galvanised steel.

### CROSS-REFERENCE TO RELATED APPLICATIONS

This application claim priority to Australian Application No. 2021282399, filed Dec. 6, 2021, which is incorporation herein by specific reference.

### FIELD OF THE INVENTION

The present invention relates to an intumescent cover or joiner applicable to a thermal insulation panel system.

One or more particular applications of the present invention relates to an intumescent cover or joiner arrangement, such as applicable to a structural fire protection panel system for marine applications.

### BACKGROUND TO THE INVENTION

Intumescent materials are used for a variety of passive fire protection applications. Such intumescent materials generally comprise a combination of heat resistant inorganic fibers/fibres and an intumescent substance.

In use, the intumescent material is applied to a surface to be protected from fire. In the event of a fire, the intumescent material expands to form an effective seal against the passage of fire and smoke and helps to minimise heat transfer.

Thermal insulation panels have previously been used in a variety of industries including the transportation, aviation, shipping and construction industries. Regulations mandate compliance with fire resistance and non-combustibility standards.

In marine applications, there is a requirement for fire safety rated firewalls, insulation for structural fire protection and fireproof panels for bulkheads and deckheads in fire zones and other ship compartments for protection against fire.

For example, under certain international marine regulations, fireproofing means the vessel structure must be insulated from exposure to temperatures of up to about 1700° F. (927° C.) for up to 60 minutes, depending upon the location of the vessel's bulkhead and/or deckhead, to prevent structural failure.

Bulkheads and deckheads of a vessel are typically fire protected by using insulation blankets or insulation panels that are fastened to the faces and/or stiffeners of the bulkheads and deckheads during ship construction. Insulation blankets and panels necessarily have joints between adjacent units, which must be protected to minimise the passage of heat and stop the passage of flame through the fire protection system. Insulation panels are often constructed from steel sheets with mineral fibre blankets attached to their reverse sides. In the heat of a fire, the steel sheets can bend and twist, which can open up gaps at the joints by which heat and flame can breach the fire protection system. In addition, everyday movements of the ship structure can open up small gaps at panel joints, which a fire can subsequently exploit.

With the aforementioned in mind, it would be advantageous to provide a cover or joiner for one or more joints between panels of a thermal insulation panel system that ameliorates one or more disadvantages of known thermal panel arrangements or at least provides an alternative arrangement to cover or seal joints between panels of such panel systems.

It is to be understood that, if any prior art is referred to herein, such reference does not constitute an admission that the prior art forms a part of the common general knowledge in the art, in Australia or any other country.

### SUMMARY OF THE INVENTION

An aspect of the present invention provides a cover or joiner providing thermal protection for one or more joints between thermal insulation panels of a structural fire protection system, the cover or joiner including a non-combustible substrate supporting an intumescent thermal insulation material, the cover or joiner configured to respectively cover or join one or more joints between panels of non-combustible material of the thermal insulation panel system, the intumescent thermal insulation material expanding on exposure to sufficient heat to provide a thermal and flame-tight seal at the joint between the panels.

Embodiments can comply with requirements for thermal insulation panel systems meeting the International Convention for the Safety of Life at Sea (SOLAS) standard and/or International Maritime Organization (IMO) standards for non-combustible thermal insulation panel systems for marine vessel applications.

Embodiments include a cover or joiner arrangement for respectively covering or retaining joints between thermal insulation panels of a structural fire protection system.

The cover or joiner arrangement may include at least one elongate channel member incorporating intumescent thermal insulation material.

In the event of a fire, the intumescent thermal insulation material expands to seal one or more gaps at joins between adjacent panels, thereby preventing the passage of flame and minimising the transmission of heat through the structural fire protection system.

The intumescent thermal insulation material may include or consist of alkaline earth silicate (AES) mineral fibre insulation.

The cover or joiner, such as the at least one elongate channel member embodiment(s), may span a join between adjacent panels. The elongate channel member may be U or C shaped in cross section. Preferably the intumescent insulation material resides predominantly within the U or C shaped channel prior to intumescing. The intumescent insulation material may be bonded and/or physically retained (such as by fasteners or the edges of the elongate member. Preferably metal edges of the elongate member can contact front faces of respective panels when the cover or joiner is applied over the joint between two panels. The respective channel member may house the intumescent thermal insulation material.

The cover or joiner may be a component part for a support structure to support the respective at least one of the panels.

The substrate of the cover or joiner may be or include metal, such as stainless steel or galvanised steel.

The intumescent insulation material contained within the cover or joiner may not itself need to be classed as a non-combustible material.

The cover or joiner may include a channel portion with the intumescent material therein.

A further aspect provides a cover or joiner arrangement for thermal insulation panels of a structural fire protection system, the cover or joiner arrangement including at least one said respective cover or joiner of any one of the preceding claims.

The cover or joiner arrangement may be part of a marine vessel bulkhead and/or deckhead said thermal insulation panel system.

The cover or joiner arrangement may be provided as part of a support structure to support the respective at least one thermal insulation panel.

The cover or joiner arrangement may be part of a metal framework, such as a steel framework.

One or more corner intersections of a plurality of the thermal insulation panels may be supported by a respective corner connector of the cover or joiner arrangement.

The thermal insulation panel system may be a marine vessel bulkhead and/or deckhead thermal insulation panel system.

The cover arrangement or joiner arrangement may be connected to or form part of a supporting substructure, such as a framework, such that adjacent insulation panels can be secured to the supporting substructure. The panels may be secured to or otherwise retained in the framework. Screw fasteners, rivets or clips, or a combination of two or more thereof, may be employed. The covers or joiners can therefore be quickly removed to access services (e.g., electrics, plumbing) behind the thermal panels, which is very desirable.

Longitudinal joints between the thermal panels of the thermal panel system may be connected with one or more respective said joiner arrangements.

Preferably the cover or joiner may include thermal insulation (e.g., 6 mm thick intumescent insulation). The cover or joiner may be fastened (e.g., screwed, rivetted or clipped) to the framework (e.g., at nominal 600 mm spacing).

One or more corner intersections of four of the thermal panels may be supported by a respective corner connector. For example, a metal corner support bracket.

The cover or joiner may include a cover plate, which may be configured to provide the thermal insulation protection for joints between three, four or more panels, such as a corner joint where corners of four of the thermal panels meet.

Such a corner cover plate (which may be of or include pressed stainless steel or galvanised steel) may include the intumescent thermal insulation material e.g., with 6-10 mm thick intumescent insulation, to restrict or prevent the passage of heat and flame at the panel corners.

It will be appreciated that one or more embodiments of the present invention provides a bulkhead or deckhead structural thermal/fire protection system including one or more of the covers or joiners of one or more embodiments of the present invention.

The panel system can include insulated panels (e.g., mineral fibre blankets or panels, optionally with aluminium facing (which aluminium facing may be sacrificial to sufficient heat exposure), steel facing or other non-combustible facing material(s)) supported by steel framework (e.g., light gauge steel), preferably with an air gap, between the rear of the thermal insulation panels and a marine vessel bulkhead or deckhead.

The structural support or framework and thermal insulation panels may be attached to a bulkhead, such as using stand-off brackets (which preferably also provides the air gap) or suspended below a deckhead, such as supported by hangers (which may preferably provide the required airgap).

An air gap (as mentioned above) of at least 150mm is preferably maintained between the (aluminium or steel) deckhead or bulkhead and the reverse (non-fire) side of the panel system.

The fasteners may be fitted with metal eyebolts with an optional rubber grommet. Metal (e.g., steel) suspension rods/brackets may be provided between the eyebolts and the framework e.g., at nominal 1300 mm centers/centres

The suspending rods are preferably hooked into a steel grid structure which supports the thermal panels e.g., by supporting the metal sheet panels, to suspend the panel system below the deckhead. Additional support brackets may be attached to the marine vessel (e.g., ship) structure, where required for a particular application.

Clips and hanger arrangements can be provided for suspending the structural fire protection system below the deckhead. The clips attach to the stiffeners of the vessel deckhead plate and hanging rods attach to the clips.

The intumescent material may include inorganic additives to increase integrity after intumescing. The intumescent material may also include a binder material, such as a binder at around 5% of the overall content of the intumescent material, or combinations thereof.

It is to be recognised that other aspects, preferred forms and advantages of the present invention will be apparent from the present specification including the detailed description, drawings and claims.

There is no intention to limit the present invention to the specific embodiments shown in the drawings. The present invention is to be construed beneficially to the applicant and the invention given its full scope.

### BRIEF DESCRIPTION OF THE DRAWINGS

One or more embodiments of the present invention will hereinafter be described with reference to the accompanying drawings, in which:

FIG. 1A shows a plan view reverse side of a sheet steel tray, without insulation attached, as in FIG. 1C, for a structural fire protection system.

FIG. 1B1 shows an end view, with insulation attached, and FIG. 1 B2 shows a close-up section from FIG. 1B1 of a known thermal insulation panel of non-combustible materials for a structural fire protection system.

FIG. 1C shows a perspective view of the reverse side of a sheet steel tray shown in FIG. 1A.

FIG. 1D shows a perspective view of the same known thermal insulation panel of non-combustible materials, including a sheet steel tray and insulation material assembled together using steel pins.

FIGS. 2A, 2B and 2C show components of a steel framework structure for use with or in an embodiment of the present invention.

FIG. 2D standoff bracket (such as for mounting to a bulkhead or deckhead) to which a framework channel of FIGS. 2A, 2B and 2C is attached.

FIGS. 3A and 3B show respective cross section and plan views of a cover or joiner according to an embodiment of the present invention.

FIGS. 4A and 4B show examples of a corner intersection cover plate according to an embodiment of the present invention.

FIG. 5 shows a thermal insulation panel system for a bulkhead and utilising a number of cover or joiner arrangements according to an embodiment of the present invention.

FIG. 6 shows a combination of a thermal insulation panel system applied to a bulkhead and to a deckhead and utilising a number of joiner arrangements according to an embodiment of the present invention.

FIGS. 7A to 7D show portions of an application of a thermal insulation panel system to a bulkhead incorporating a cover or joiner arrangement according to an embodiment of the present invention.

FIGS. 8A to 8E show portions of an application of a thermal panel system to a deckhead incorporating a cover or joiner arrangement according to an embodiment of the present invention.

### DESCRIPTION OF PREFERRED EMBODIMENT

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

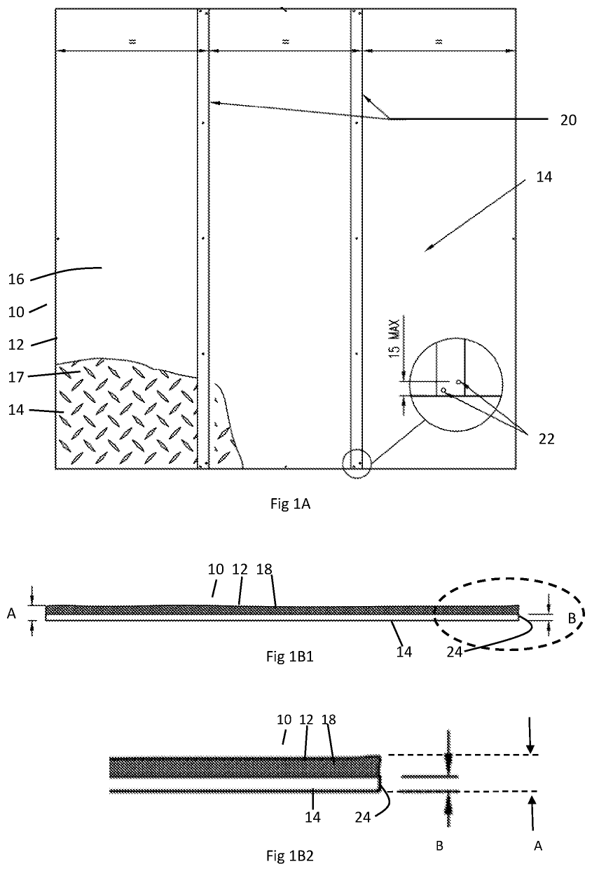

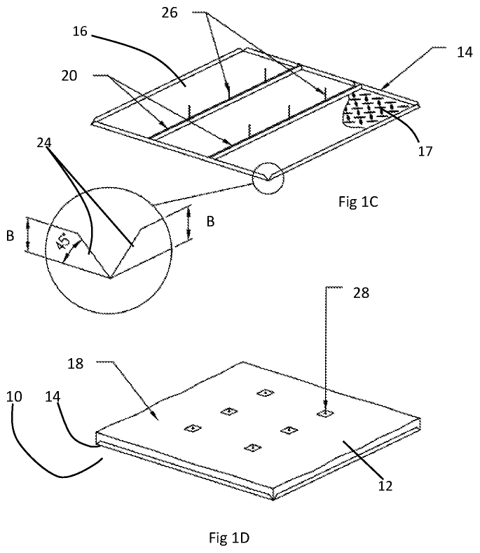

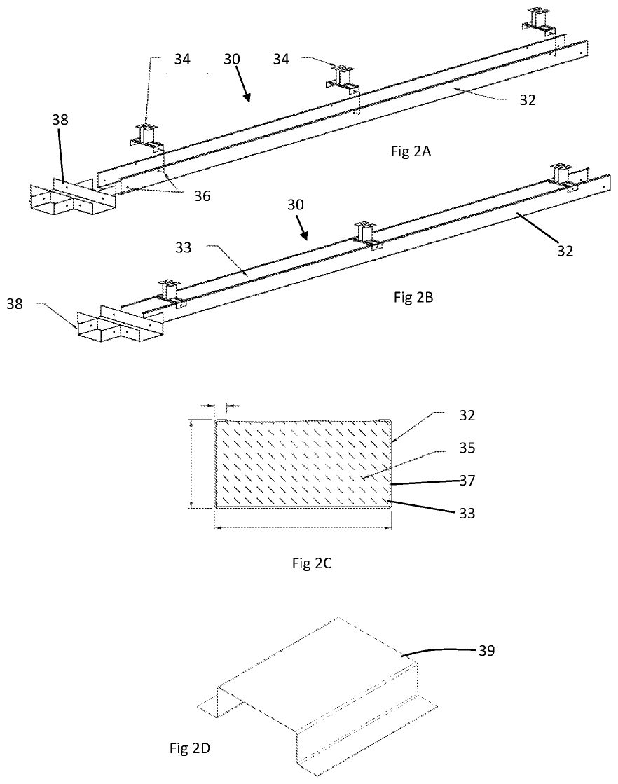

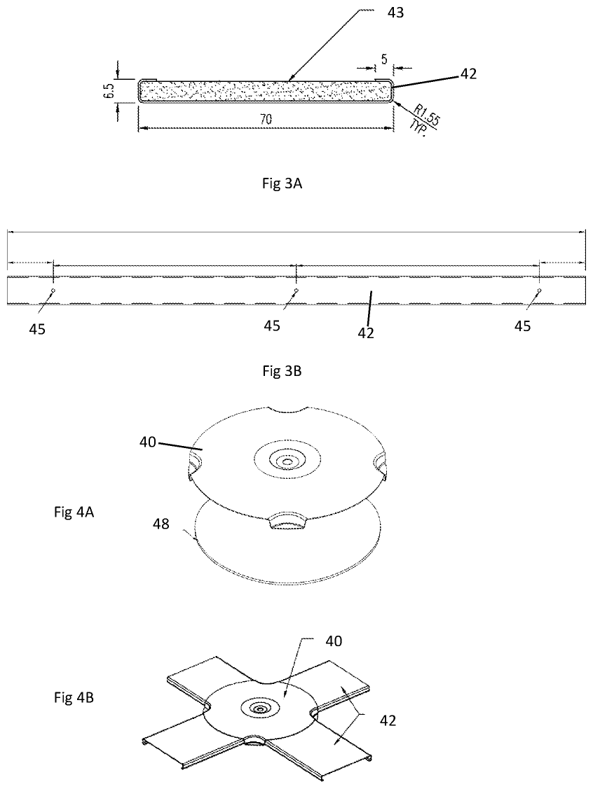

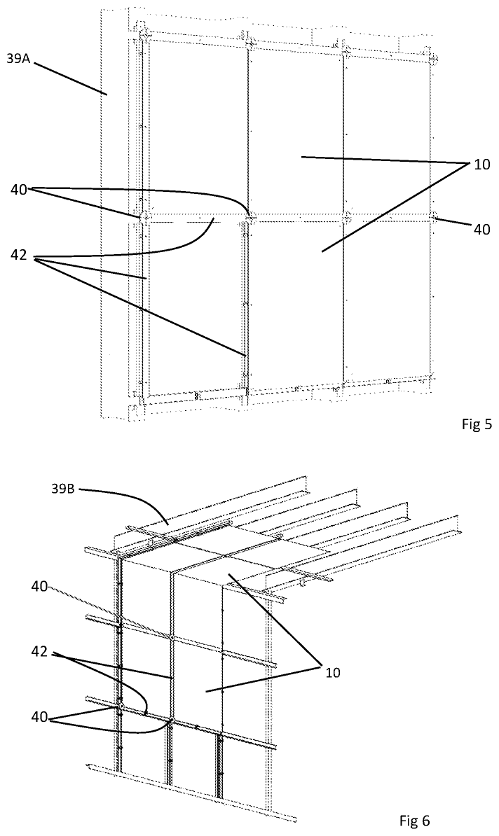

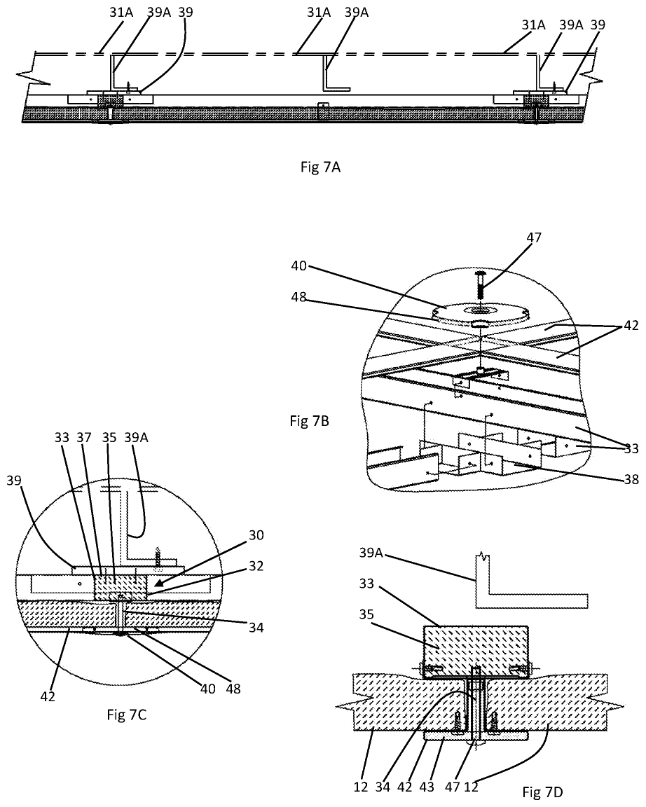

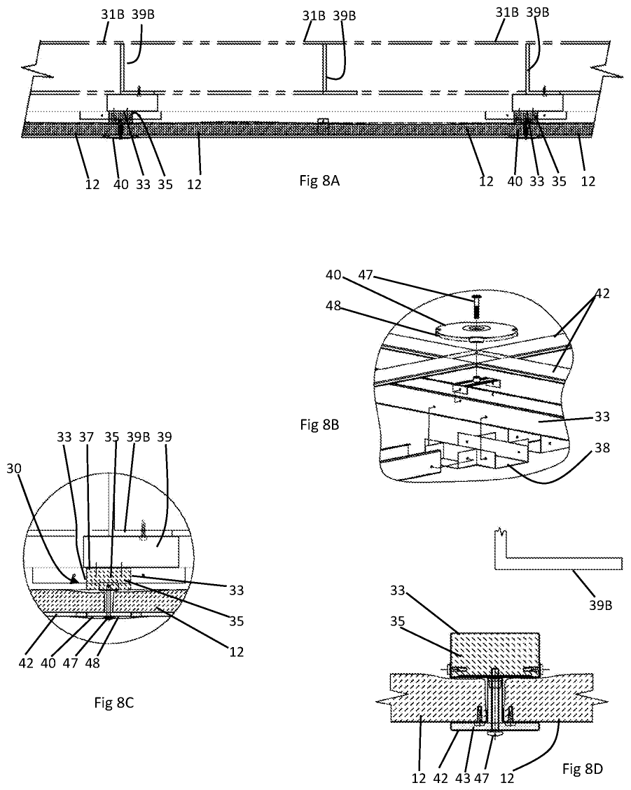

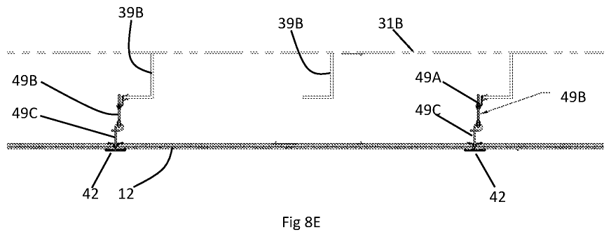

A thermal insulation panel system includes at least one thermal insulation panel 12 including a sheet steel tray 14 supporting at one face 16 thereon a non-combustible thermal insulating material 18 (see FIG. 1D).

The face 16 of the sheet metal panel may be embossed or otherwise textured 17. FIG. 1A shows partial embossing/texture but it will be appreciated that most or all of the face of the sheet steel tray 14 can be embossed/textured.

FIG. 1B1 shows an end view of the thermal insulation panel 12 of non-combustible materials with sheet steel tray 14 and thermal insulation material 18 providing a thickness A, and the sheet steel tray 14 with support edges 24 providing depth B to the tray structure. FIG. 1B2 shows a close-up end portion of FIG. 1B1, as identified in FIG. 1B1.

The sheet steel tray 14 includes at least one longitudinal steel stiffener 20, which may be spot welded 22 directly to the sheet steel tray 14.

One or more pins 26 (such as steel pins) can be attached to or otherwise form part the respective stiffener 20. The respective pin/pins may be used to provide positions for fastening the insulation material to the rear face of the sheet steel tray 14. It is preferred that the insulation material is continuous across a rear face of the respective thermal insulation panel.

One or more retainers 28 can be attached to the pins 26 to retain the insulation material to the rear face 16 of the sheet steel tray 14.

A support framework arrangement 30 can be attached to a bulkhead 31A or suspended from deckhead 31 B, such as by using a number of stand-off brackets 39 attached to respective bulkhead or deckhead stiffeners (39A, 39B) being part of the bulkhead and deckhead structures of the vessel structure.

Alternatively, clips 49 (e.g., Erico Caddy clips) with a steel leg 49A, installed onto the flange 39C of a deckhead stiffener 39B can be used to suspend from the deckhead 31B using eyebolts 49B and hanging rods 49C.

Preferably, an air gap of at least 150mm, preferably at least 200mm, is maintained between the bulkhead and/or deckhead and the reverse (non-fire) side of the panel 12 of the panel system 10.

The support framework arrangement 30 can include a support channel arrangement 32 including at least one channel 33 (which can have a U profile), and can be insulated, such as with AES mineral fibre insulation material 35, within a section/profile 37 of the respective channel 33.

One or more brackets 34 can be provided to retain the thermal insulation panel(s) 12 to respective channel 33. Fastener arrangements 36 can be provided to connect brackets, corners etc. to retain together components of the framework, such as by screws or rivets etc.

Corner joiners 38 can be provided to connect corners of the joiner arrangement and to allow corner intersections of the thermal insulation panels to be covered, such as by cover pieces 40.

One or more stiffener standoff brackets 39 can be provided to attach to the stiffeners of the vessel bulkhead or deckhead structure. Respective channels 33 can be attached to the stiffener standoff brackets 39.

At least one cover or joiner 42 embodying the present invention is provided to cover the respective channels and/or joins between adjacent thermal insulation panels 12.

The or each cover or joiner may include an elongate member 42, such as a strip, that includes intumescent insulation 43, and optionally can include one or more fastener arrangements, such as use of holes 45 for attaching the cover or joiner 42 to the underlying thermal insulation panels and support framework.

The cover or joiner 42 can be insulated with 6mm thick intumescent insulation material (such as facing the panels) and attached (e.g., screwed) to the framework at nominal spacings. The front face of the cover or joiner (front facing away from the panels) can be of metal, such as steel.

Clips can be attached to the stiffeners of the vessel deckhead structure 39B, which can be fitted with M6 steel eyebolts with an optional rubber grommet. Suspension rods can be installed between the eyebolts and the steel support framework at nominal centres. The suspending rods provide the required minimum airgap between the reverse side of the structural fire protection system and the deckhead. Additional support brackets can be attached to the vessel structure where required.

Each intersection of a number of the panels is preferably covered with a intersection cover, such as a plate (e.g., a pressed stainless steel or galvanised steel corner cover 40), which may be retained by a fastener 47. Preferably the intersection cover is insulated with 6-10mm, preferably 9.5mm, thick intumescent insulation 48.

The respective joiner or cover can be such that sufficient heat causes the intumescent insulation material to expand and seal gaps between the cover or joiner and the front faces of the respective panels at the respective joint.

The intumescent insulation material may be configured such that expansion (due to sufficient heat) casus s the intumescent insulation material to expand into any gap at the join between two adjacent panels.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

What is claimed is:

1. A cover or joiner providing thermal protection for one or more joints between thermal insulation panels of a structural fire protection system, the cover or joiner including a non-combustible substrate supporting an intumescent thermal insulation material, the cover or joiner configured to respectively cover or join one or more joints between panels of non-combustible material of the thermal insulation panel system, the intumescent thermal insulation material expanding on exposure to sufficient heat to provide a thermal seal at the joint between the panels.

2. The cover or joiner of claim 1, wherein the intumescent thermal insulating material includes alkaline earth silicate (AES) mineral fibre insulation.

3. The cover or joiner of claim 1, being a component part for a support structure to support the respective at least one of the panels.

4. The cover or joiner of claim 1, being an elongate member for respectively covering or joining longitudinal joints between adjacent said panels.

5. The cover or joiner of claim 1, being a corner cover or joiner for a plurality of corners of the panels.

6. The cover or joiner of claim 1, wherein the substrate includes steel.

7. The cover or joiner of claim 1, wherein the cover or joiner is not entirely of non-combustible material.

8. The cover or joiner of claim 7, wherein the intumescent material is not classed as a non-combustible material.

9. The cover or joiner of claim 1, wherein the cover or joiner includes a channel portion with the intumescent material therein.

10. A cover or joiner arrangement for a thermal panel system of a structural fire protection system, the cover or joiner arrangement including at least one said respective cover or joiner as recited in claim 1.

11. The cover or joiner arrangement of claim 10, being part of a marine vessel bulkhead and/or deckhead of said thermal insulation panel system.

12. The cover or joiner arrangement of claim 10, the cover or joiner arrangement provided as part of a support structure to support the respective at least one thermal panel.

13. The cover or joiner arrangement system of claim 12, wherein the cover or joiner arrangement is part of a metal framework, such as a steel framework.

14. The cover or joiner arrangement of claim 10, wherein one or more corner intersections of a plurality of the thermal panels is supported by a respective corner connector of the cover or joiner arrangement.
